(19) United States
(12) Patent Application Publication
(10) Pub. No.: US 2026/0340352 A1
(43) Pub. Date: Oct. 29, 2026

(54) ADAPTIVE MULTI-PASS CHUNKING

(71) Applicant: SAP SE, Walldorf (DE)

(72) Inventor: Nikhil Gajendrakumar, Santa Monica, CA (US)

(21) Appl. No.: 19/193,395

(22) Filed: Apr. 29, 2025

(51) Int. Cl. G06N 3/0455

(52) U.S. Cl. CPC G06N 3/0455

(57) ABSTRACT

In an example embodiment, an adaptive multi-pass chunking (AMPC) technique is introduced. AMPC utilizes a multi-pass chunking process that progressively refines document segmentation by first applying global context-based chunking and then enhancing those chunks using context-specific semantic refinement. This method leverages both static and dynamic signals to ensure that chunks capture both local coherence and global context relevance.

### TECHNICAL FIELD

This document generally relates to computer systems. More specifically, this document relates to use of large language models used in computer systems.

### BACKGROUND

A large language model (LLM) refers to an artificial intelligence (AI) model that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a flow diagram illustrating a method for performing adaptive multi-pass chunking (AMPC), in accordance with an example embodiment.

FIG. 2 is a block diagram illustrating operations 104-106 of FIG. 1 in more detail, in accordance with an example embodiment.

FIG. 3 is a diagram illustrating operation 108 in more detail, in accordance with an example embodiment.

FIG. 4 is a diagram illustrating operation 110 of FIG. 1 in more detail, in accordance with an example embodiment.

FIG. 5 is a block diagram illustrating operations 112 and 114 of FIG. 1 in more detail, in accordance with an example embodiment.

FIG. 6 is a block diagram illustrating components of a machine learning system, according to some examples.

FIG. 7 is a flowchart illustrating a machine learning pipeline, according to some examples.

FIG. 8 is a system architecture diagram showing a layered view of an artificial intelligence (AI) integrated system, according to some examples.

FIG. 9 is a block diagram illustrating a software architecture, which can be installed on any one or more of the devices described above.

FIG. 10 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

One of the biggest technical challenges involved in using LLMs for code generation is providing the correct context. LLMs operate better when they are not just provided with bare requests for generation (e.g., “generate me some code to do X”) but are also provided with some contextual information, such as the location of the code in which the newly generated code is to be placed, related files with important definitions, etc. The more context the LLM has for a request, the better the reliability of code generation will be. If one were to hypothetically provide every code snippet in an entire application's worth of code to the LLM, then the resultant code generated would be very reliable.

LLMs can also be used for other types of tasks, such as providing answers to questions, summarization, engaging in conversation, real-time insights and recommendations, workflow and automation, troubleshooting, and debugging.

The problem is that LLMs typically have a limit on how much context is able to be provided with a request (e.g., a maximum number of input tokens), and even in cases where such limits do not exist or where the limits are not quite reached, adding additional context adds to inference costs (either in money or in speed, for example). Thus, while it is important to provide relevant context for a request to an LLM, it is also important not to provide irrelevant context. Identifying relevant context, however, can be technically challenging.

One approach to handling this technical issue is to use Retrieval Augmented Generation (RAG). RAG is a framework that combines traditional retrieval techniques with generative models to improve the quality of generated responses, particularly in tasks like question answering or conversational agents.

In RAG, the process typically involves two main steps:
Retrieval: The system first retrieves relevant documents or pieces of information from a large database or knowledge base based on the input query. This can be performed using techniques like search algorithms or vector embeddings to find the most pertinent information.
Generation: After retrieving relevant information, a generative model (like an LLM) processes this data to produce a coherent and contextually appropriate response. The model can leverage the retrieved content to enhance its answers, making them more accurate and informative.

The combination allows the model to provide richer, more context-aware responses than it could generate from scratch, tapping into a larger body of knowledge while still being able to generate natural language. RAG is particularly useful in scenarios where real-time access to up-to-date information is critical.

In the case of vector embeddings, a vector embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the texts with similar semantics will have the corresponding similar embeddings.

Thus, vector embeddings may be combined with RAG to provide improved LLM generation. Specifically, an embedding machine learning model is trained on a large corpus of text and then used to perform the embedding of the underlying text into embeddings. This allows similar pieces of text to be identified even from text that is different. For example, text including the term “apartment” may be similar to text including the term “flat”, even though their words are completely different. Thus, the embeddings for these two words may be geometrically close to each other in the latent n-dimensional space.

A technical issue arises, however, when embedding large documents. Embedding the entire large document as a whole is virtually worthless because the embedding becomes so specific to the document as a whole that it is nearly impossible to identify similar embeddings to it, and even if a similar document were found it would not be that helpful because it would not be clear which parts of the documents were similar.

One could, however, split the document into multiple chunks and embed each chunk separately. For example, if the document is ten pages long, the document could be split into ten chunks, each being a page long. While this makes identifying text similar to a particular page of a document more accurate when just taking the view of the particular page, there is some information loss when these techniques are applied to chunks in this manner. Specifically, while intra-chunk context (e.g., contextual relationships between words or concepts within a single page) is captured using this technique, inter-chunk context (e.g., contextual relationships between words or concepts between two pages) is not captured. Thus, if how the document is chunked is not performed with care, the reliability of the text generated based on embeddings of the chunks, even when using RAG, will suffer.

Indeed, this problem is exacerbated when chunks are even smaller, such as being one sentence per chunk. There is even more information loss as the chunks get smaller and smaller. As common as it is for text on one page of a document to be related to another page of the document, it is even more common for text in one sentence of a paragraph to be related to the next sentence in that paragraph.

More specifically, traditional chunking methods, such as fixed-length chunking, heading-based chunking, sentence-level chunking, and sliding window chunking, often struggle to maintain the semantic coherence of the original document. Semantic coherence refers to the logical flow and meaning of the text. When this is disrupted, the chatbot may provide fragmented or disjointed responses.

Fixed-length chunking divides text into chunks of a predetermined number of tokens or words. While simple, this method can split text in the middle of sentences or paragraphs, losing context. Heading-based chunking uses document headings to create chunks. This approach can result in uneven chunk sizes, with some sections being too large for the model's context window and others too small, leading to inefficient use of token space. Sentence-level chunking creates chunks based on a fixed number of sentences. This method preserves sentence boundaries but may still disrupt larger thematic ideas.

Sliding window chunking creates overlapping chunks, where each chunk shares some content with the previous one. This helps carry over context between chunks but increases the number of tokens processed, leading to inefficiency and redundancy. Redundancy can reduce the quality of embeddings, which are numerical representations of text used by models to understand and generate responses.

The core challenge with chunking documents lies in balancing semantic coherence and efficient processing. Fixed-length and sentence-level chunking struggle with semantic boundaries, often cutting across sentences or paragraphs, which can hinder the model's comprehension. On the other hand, heading-based and sliding window approaches attempt to preserve context but introduce problems like uneven chunk sizes and redundant processing.

LLMs need to provide accurate and context-aware responses, and thus these issues can severely limit performance. Losing important context or having incomplete chunks makes it challenging for the LLM to generate relevant answers, while inefficiency due to redundance impacts scalability.

In an example embodiment, an adaptive multi-pass chunking (AMPC) technique is introduced. AMPC utilizes a multi-pass chunking process that progressively refines document segmentation by first applying global context-based chunking and then enhancing those chunks using context-specific semantic refinement. This method leverages both static and dynamic signals to ensure that chunks capture both local coherence and global context relevance.

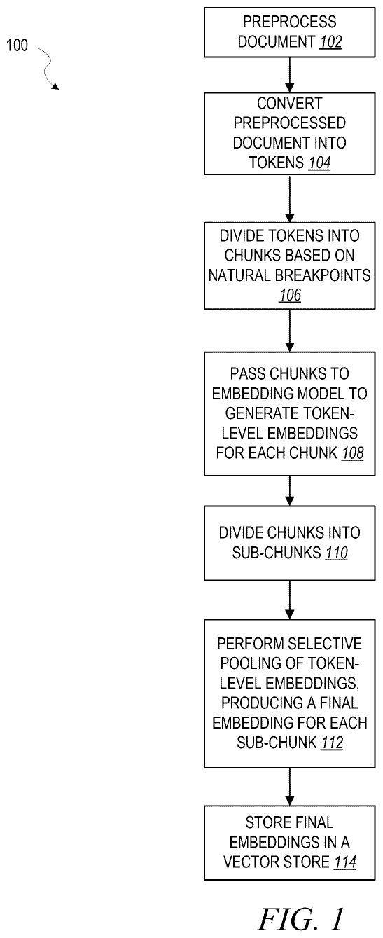

FIG. 1 is a flow diagram illustrating a method 100 for performing AMPC, in accordance with an example embodiment. At operation 102, a document to be chunked is preprocessed. Here, preprocessing involves converting the document to a standardized format across all possible input document types. In an example embodiment, this standardized format is the Markdown format. Markdown is a lightweight markup language that provides for formatted text using plain text syntax. Headers are created using the # symbol, and the number of # symbols represents the level of the header. For example, one # creates a top-level header, and more # symbols create sub-level headers.

To emphasize text, one uses asterisks (*) or underscores (_). One asterisk or underscore around a word makes it italic, and two asterisks or underscores make the word bold. One can also combine three asterisks or underscores to create bold and italic text.

For lists, unordered lists are made by using dashes (−), plus (+), or asterisks (*) followed by a space. Ordered lists are created using numbers followed by a period. Subitems in both types of lists are indented. Links are created using square brackets for the text and parentheses for the URL. To create an image, one uses the same syntax as a link but place an exclamation mark (!) before the square brackets. Blockquotes are created using the greater-than symbol (>), and they allow the user to format longer quotes in a different style. Inline code can be created by surrounding the code with single backticks (′). For multi-line code blocks, one can use triple backticks (′″). A horizontal line is created using three dashes (- - - ), asterisks (***), or underscores (___). Tables in Markdown are formatted using pipes (|) to separate columns and dashes (−) to create the header row. A table can have any number of columns and rows. Strikethrough text is made by surrounding the text with two tilde symbols (~~).

Thus, no matter what format the original document is stored in (e.g., plain text, Word, PDF, JSON, HTML, etc.), at operation 102 it is converted to a Markdown file.

At operation 104, the Markdown file is converted into tokenized form by passing it through a tokenizer. The tokenizer transforms the text into a series of tokens, each representing a word, symbol, or character group, depending on the tokenizer's rules.

At operation 106, the tokens are divided into chunks based on natural breakpoints. These natural breakpoints may be headings, topics, chapter markers, etc. By utilizing these structural markers, the chunks can retain meaningful context, avoiding the disruption of logical segments like paragraphs, headings, or sections. The goal is to maximize the number of tokens used within each chunk without exceeding the context window of the embedding model, which will be described later. For example, the embedding model may have a context window limit of around eight thousand, one hundred, and ninety-two tokens, and thus the tokens are divided to ensure that the number of tokens in each chunk does not exceed this size.

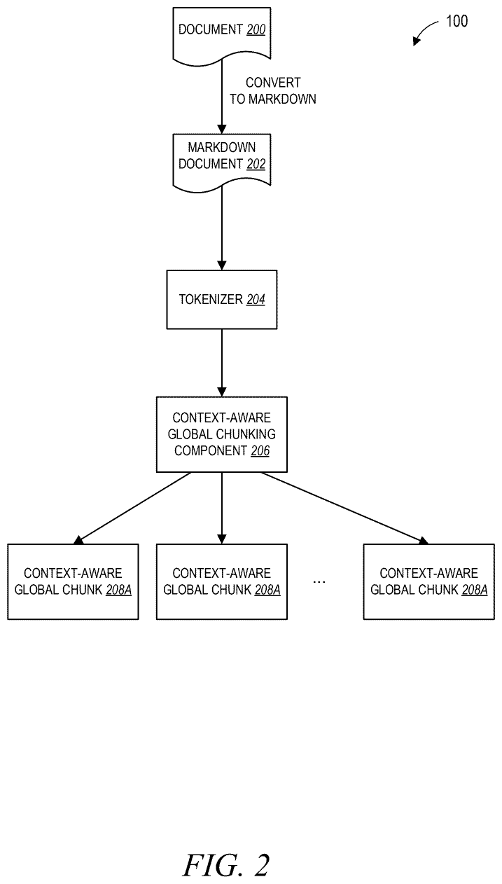

FIG. 2 is a block diagram illustrating operations 104-106 of FIG. 1 in more detail, in accordance with an example embodiment. More specifically, a document 200 is converted to a Markdown document 202, which is then passed to a tokenizer 204. Tokens from the tokenizer are passed to a context-aware global chunking component 206, which then splits the tokens into context-aware global chunk 208A, global chunk 208B . . . global chunk 208N.

These chunks are called “context-aware” because they preserve the document's logical flow and coherence by aligning with its structure, while the term “global” reflects the approach of considering the document's overall context during the chunking process. This method optimizes embedding quality by maintaining the contextual relationships between different parts of the document, allowing for more accurate and meaningful embeddings.

Referring back to FIG. 1, at operation 108, the context-aware global chunks are passed to an embedding model. In some example embodiments, the embedding model may be a transformer-based embedding model. In traditional transformer-based embedding models, the input tokens are transformed into high-dimensional vectors through multiple layers of attention and feed-forward neural networks, and the token-level embeddings are averaged in a mean pooling layer to produce a single embedding for the entire chunk. In the present case, however, a unique transformer-based embedding model is used where the mean pooling layer is not used. As will be seen below, the token-level embeddings will be used directly to provide global context to local embeddings. In other words, each token in the chunk retains its individual embedding, preserving token-specific context information rather than collapsing it into a single vector.

The output of the embedding model in this case would be a matrix where each row corresponds to the embedding of an individual token from the input chunk. The dimensions of this output would depend on two factors: the number of tokens in the chunk and the size of the hidden layer in the model. One example model, each token is represented by a 1,536-dimensional vector. Therefore, if a chunk contains n tokens, the output would be an n×1536 matrix, where n is the number of tokens in the chunk, and 1536 is the size of each token's embedding vector. This token-level granularity provides more detailed information about the chunk, allowing for more nuanced downstream processing or further transformations.

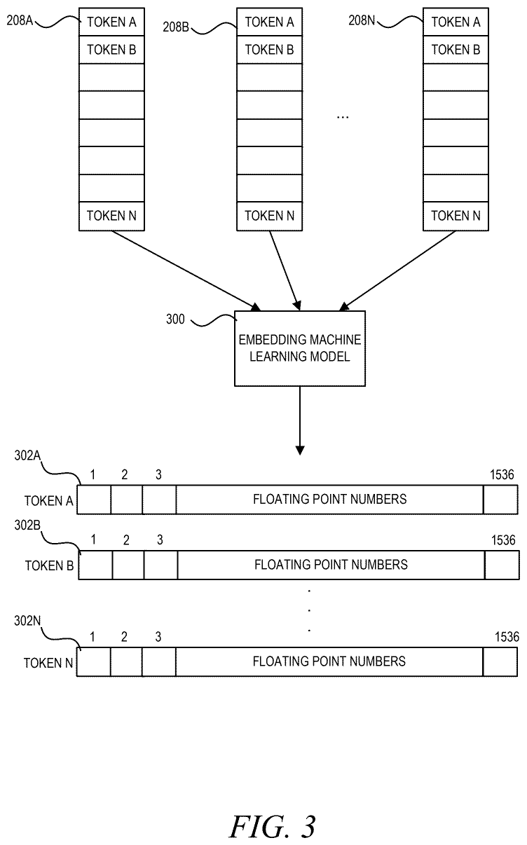

FIG. 3 is a diagram illustrating operation 108 of FIG. 1 in more detail, in accordance with an example embodiment. Here, context-aware global chunk 208A, context-aware global chunk 208B, context-aware global chunk 208N are passed to an embedding model 300, which produces, for each chunk, a set of n vectors, which are token-level embeddings, specifically token-level embedding 302A, token-level embedding 302B, . . . , token-level embedding 302N.

Referring back to FIG. 1, at operation 110 the tokens and embeddings for the context-aware global chunks are further divided into sub-chunks. More specifically, the text corresponding to each chunk is taken from the Markdown file and split into sections, such as by paragraph. This may be accomplished by, for example, using the Markdown markers. For ease of discussion, these will be referred to here as paragraphs, although they may be any type of section or division.

In a further example embodiment, each paragraph may be submitted to an LLM with instructions to summarize the paragraph. The summaries, beginning with the second summary, can then be submitted to the LLM with instructions to determine whether the summary continues an idea from the previous summary or begins a new topic. If the summary continues the idea from the previous summary, then the corresponding paragraph is combined with the paragraph before it. Thus, continues for each summary iteratively (e.g., if a third paragraph is combined with a second paragraph, the newly combined paragraph could potentially be further combined with the fourth paragraph if the LLM determines it should be so). After this process is complete, what is left are sub-chunks of grouped or ungrouped paragraphs.

For each of these sub-chunks, the corresponding embeddings are then grouped together.

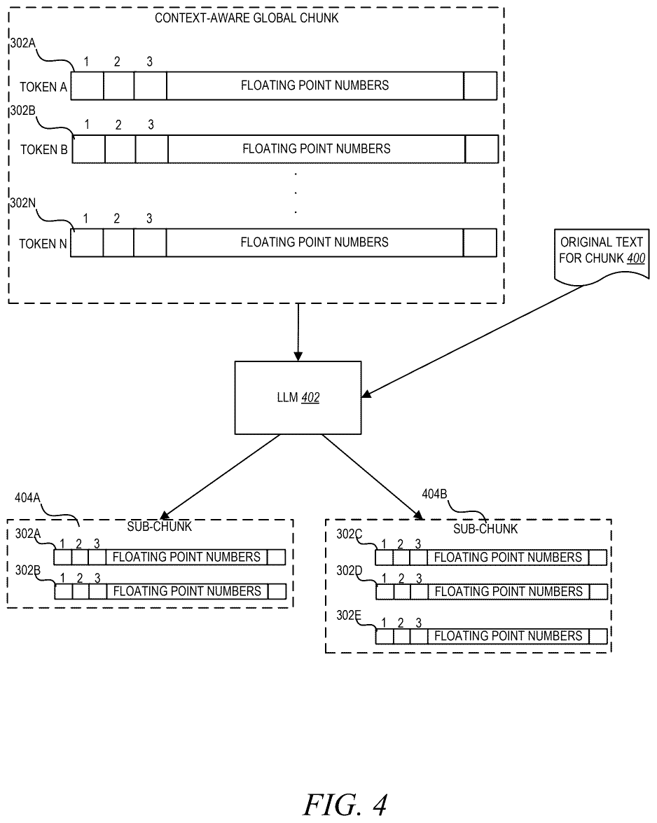

FIG. 4 is a diagram illustrating operation 110 of FIG. 1 in more detail, in accordance with an example embodiment. Here, the set of token-level embeddings 302A, 302B, . . . , 302N for a particular context-aware global chunk along with the original text 400 of the chunk are used by, for example an LLM 402, to split the context-aware global chunk into sub-chunks 404A, 404B. Each sub-chunk 404A, 404B contains the individual token-level embeddings 302A, 302B, 302C, 302D, 302E corresponding to the text within the sub-chunk 404A, 404B.

Referring back to FIG. 1, at operation 112 selective pooling of token-level embeddings is performed. The idea here is that a global average of all token-level embeddings will be computed and then, for each sub-chunk, the sub-chunk's own token-level embeddings will be averaged. A weighted sum of the sub-chunks' own average and the difference between the global average and the sub-chunk's own average will then be calculated. This technique ensures that each chunk's embedding captures both the local context and the global context, which helps create embeddings that are sensitive to both the chunk's content and the overall document's content.

For selecting pooling, if the embeddings have a dimensionality of 1536 (which corresponds to the output size of the embedding model) and for each chunk there are t tokens, then let Eᵢ∈ [symbol] ^{t}^{ᵢ}^{×1536} be the embedding matrix for the i-th sub-chunk, where tᵢ is the number of tokens in the chunk. Additionally, N be the total number of sub-chunks.

For each sub-chunk Eᵢ, an average embedding vector, which is the mean of all the token embeddings in that sub-chunk, may be computed. The average embedding eᵢ∈ [symbol] ¹⁵³⁶ for sub-chunk i is calculated as:

$${e}_{i} = \frac{1}{{t}_{i}} {\sum }_{j = 1}^{{t}_{i}} {e}_{ij}$$

where eᵢ∈ [symbol] ¹⁵³⁶ is the embedding vector for the j-th token in sub-chunk i, and tᵢ is the number of tokens in that sub-chunk.

Next, the average of all the average embeddings of all sub-chunks may be computed, denoted as e_{global}:

$${e}_{global} = \frac{1}{N} {\sum }_{i = 1}^{N} {e}_{i}$$

where N is the number of self-sustaining sub-chunks.

For each sub-chunk i, a weighted combination of its own average eᵢ and the average of remaining (N−1) sub-chunks: e_{global}−eᵢ, may be computed.

Let α=0.8 (as given), which is the weighting factor for the current sub-chunk's average embedding, and 1−α=0.2 for the average embedding of remaining sub-chunks. The combined embedding

$${e}_{i}^{final}$$

for chunk i is given by:

$${e}_{i}^{final} = α \cdot {e}_{i} + ( 1 - α ) \cdot ( {e}_{global} - {e}_{i} )$$

‘Substituting α=0.8

$${e}_{i}^{final} = 0.8 \cdot {e}_{i} + 0.2 \cdot ( {e}_{global} - {e}_{i} )$$

eᵢ: Average embedding for sub-chunk i.
e_{global}: Global average embedding across all sub-chunk s.

$${e}_{i}^{final} :$$

Final embedding for sub-chunk chunk i, which is a weighted combination of the local and global averages, where more weight is given to the local embedding (α=0.8).

The result of the weighted sums are, for each sub-chunk, a final embedding. At operation 114, these sub-chunk final embeddings are stored in a vector store. In an example embodiment, the key in the vector store is the embedding vector

$${e}_{i}^{final} ,$$

and the value is the corresponding text from the original, context-aware global text. This allows for efficient retrieval by an LLM when answering user queries. When a user asks a question, the LLM can retrieve the most semantically relevant sub-chunks by performing a similarity search over these embeddings in the vector store, ensuring the answers are contextually appropriate based on the original content.

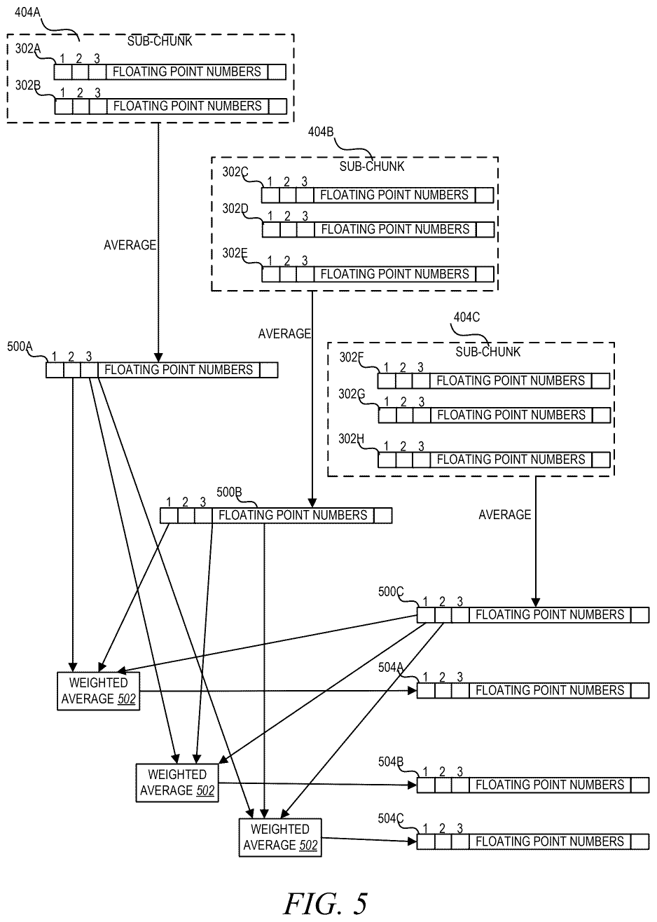

FIG. 5 is a block diagram illustrating operations 112 and 114 of FIG. 1 in more detail, in accordance with an example embodiment. Here, for example, the token level embeddings 302A, 302B of sub-chunk 404A are averaged to produce local average embedding 500A. Likewise the token-level embeddings 302C, 302D, 302E and 302F, 302G, 302H of sub-chunk 404B and 404C, respectively are averaged to produce local average embedding 500B and 500C, respectively. A weighted average 502 is then performed on the local embedding 500A along with the sum of all the local average embeddings 500B, 500C other than the local embedding 500A, to produce a final embedding 504A corresponding to sub-chunk 404A. It should be noted that this is identical to obtaining a global average of all local average embeddings and subtracting out the local embedding 500A.

Final embedding 504B and final embedding 504C are computed in a similar manner.

The final embeddings, such as final embedding 504A, final embedding 504B, and final embedding 504C are then stored in a vector store, where they can be retrieved by either the LLM or by an LLM interface component used to construct a prompt to the LLM based on a request from a user.

It should be noted that the LLM the user interacts with, that uses the final embeddings to answer questions, may or may not be the same LLM that was used previously to identify similar ideas in paragraphs/initial sub-chunks.

Furthermore, α may be fine-tuned based on user feedback. More specifically, once the chunking strategy has been used to preprocess all data and store it in the vector-store, the LLM can leverage this store to retrieve relevant information and generate responses. As the LLM interacts with users, it can gather feedback on the quality of its responses. This feedback can serve as a valuable tool to fine-tune the parameter α, which controls the balance between the local chunk's embedding and the global context across chunks. A low a places more emphasis on the global context, while a high a prioritizes the local context of the current chunk. By analyzing user feedback, we can adjust dynamically.

If responses are too general or lack relevance to the specific query, feedback may indicate that the embeddings need to focus more on the current chunk by moving closer to 1. However, both directions may be explored while tuning, as different contexts may require varying degrees of local versus global focus. If the chatbot is consistently missing broader connections between different chunks, lowering could help by incorporating more global context into the embeddings. Conversely, if responses seem too disconnected from the user's query, adjusting a closer to 1 would ensure embeddings are more aligned with the current chunk's specific content. Iteratively adjusting a based on feedback allows for a more adaptive system that can fine-tune itself to user preferences and performance metrics, ultimately improving the relevance and quality of LLM responses.

In a further example embodiment, the value of a may itself be learned or predicted by a machine-learning model. Specifically, the machine learning model may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm used to train a machine learning model may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

Training data may include information about the type of the document to be embedded, the subject matter of the documents, or any other information about the document or the document's context.

In some example embodiments, the training of these machine learning models may take place as a dedicated training phase. In other example embodiments, the machine learning models may be retrained dynamically at runtime based on, for example, developer or user feedback.

As to the LLMs used herein, LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLS™) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

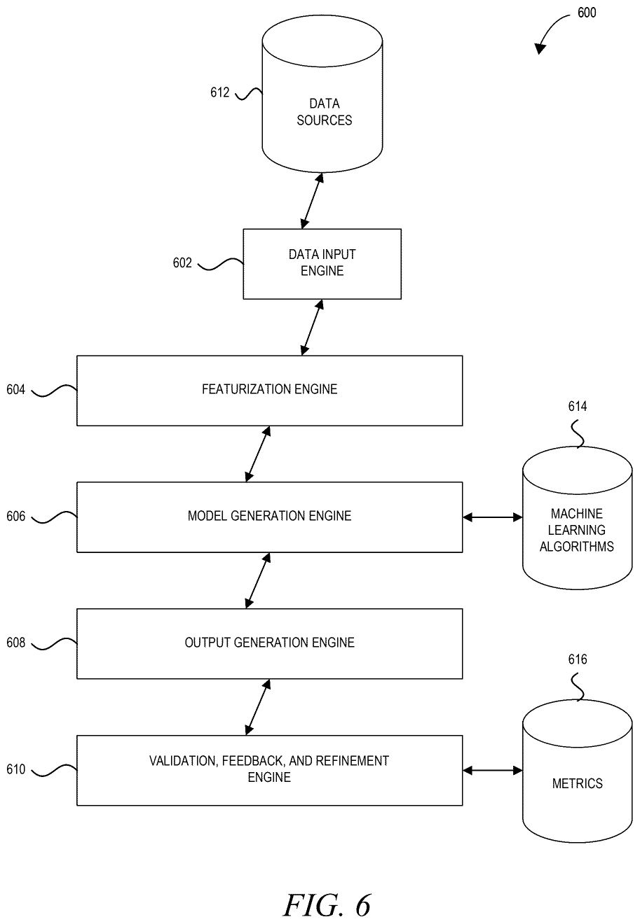

The embedding model 300 may be one of many different types of machine learning systems. FIG. 6 illustrates a machine learning system 600, according to some examples. The machine learning system 600 may be used to implement aspects of the present disclosure. The machine learning system 600 is shown to include a data input engine 602, a featurization engine 604, a model generation engine 606, an output generation engine 608, and a validation, feedback, and refinement engine 610.

The data input engine 602 may be configured to access, interpret, request, format, re-format, or receive input data from data sources 612. Data sources 612 may include training data (e.g., data for training machine learning models), validation data (e.g., data for comparing model output with known results to evaluate performance), or reference data (e.g., data used to establish baselines or inform model creation). The data input engine 602 can interact with external data systems via input/output (I/O) devices, network interfaces, or storage elements to ensure input data is processed and stored in a suitable format for further operations.

The featurization engine 604 may be configured to transform input data into features that are optimized or useful for machine learning. The featurization engine 604 can handle feature extraction, scaling, or selection, enabling the machine learning system 600 to identify and process relevant data attributes for subsequent modeling. For example, features extracted from raw data may be annotated, labeled, or transformed into numerical representations suitable for machine learning algorithms 614. The featurization engine 604 can work iteratively with other components to refine features based on model requirements or outcomes.

The model generation engine 606 is responsible for creating, training, and configuring one or more machine learning models based on input data and selected features. The model generation engine 606 may include functionality for model selection, hyperparameter tuning, or algorithm implementation.

Machine learning broadly involves using computer algorithms to automatically learn patterns and/or relationships in data, often without the need for explicit programming. Thus, the machine learning algorithms 614 may include various algorithms:

### Supervised

Classification
   Naïve Bayes
   Logistic Regression
   K-Nearest Neighbor (KNN)
   Random Forest
   Support Vector Machine (SVM)
   Decision Tree
Regression
   Random Forest
   Support Vector Machine (SVM)
   Decision Tree
   Simple Linear Regression
   Multivariate Regression
   Lasso Regression

### Unsupervised

Clustering
   K-Means Clustering
   DBSCAN Algorithm
   Principal Component Analysis
   Independent Component Analysis
Association
   Frequent Pattern growth
   A-priori Algorithm
Anomaly Detection
   Z-score Algorithm
   Isolation Forest Algorithm

### Semi-Supervised

Classification
   Self-Training
   Co-Training
Regression
   Self-Training
   Co-Training

### Reinforcement

Model-Free
   Policy Optimization
   Q-Learning
Model-Based
   Learn the Model
   Given the Model

The model generation engine 606 may also support iterative model refinement and validation cycles, enabling adaptability to evolving data or performance criteria.

In some examples, the output generation engine 608 is responsible for model inference. The output generation engine 608 processes data to produce predictions, classifications, or other results. The output generation engine 608 can also apply post-processing techniques such as aggregation, thresholding, or confidence scoring to ensure outputs are in a format suitable for downstream systems or user interpretation.

The validation, feedback, and refinement engine 610 may be configured to validate, monitor, or improve the performance and relevance of machine learning models over time. The validation, feedback, and refinement engine 610 can apply validation data to assess model outputs and integrates feedback from users or automated systems to improve models. Metrics 616 may be used to evaluate and compare model outputs against validation data or other useful data, providing insights into model performance, accuracy, reliability, or generalization. Refinement operations may involve retraining models with updated data or adjusting model parameters to account for changing conditions or newly observed patterns.

Components of the machine learning system 600 may be implemented by hardware processors and may communicate via network interfaces or shared storage elements to facilitate data exchange and coordination. The architecture shown in FIG. 6 allows for flexible deployment across various machine learning applications, such as natural language processing, computer vision, or predictive analytics.

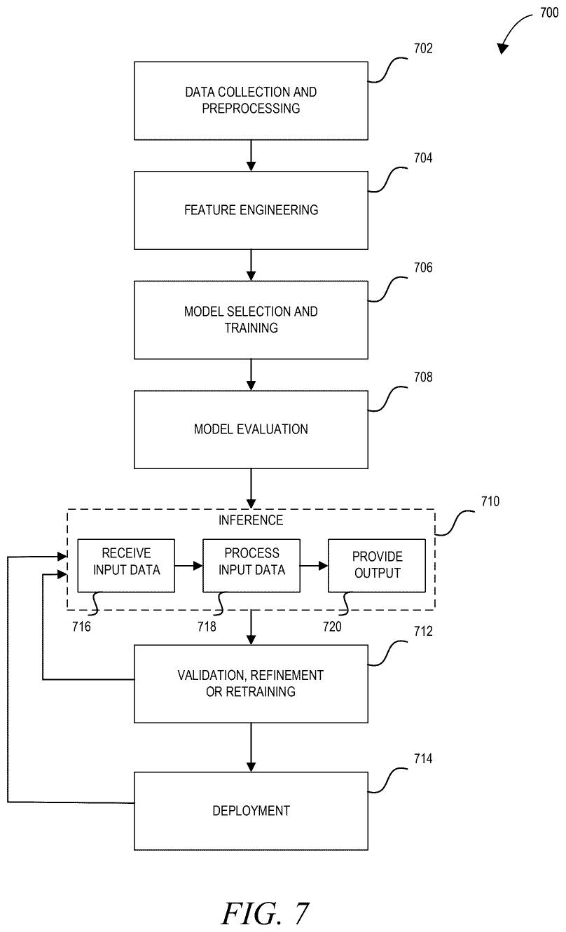

FIG. 7 is a flowchart depicting a machine learning pipeline 700, according to some examples. The machine learning pipeline 700, or parts thereof, may be used to generate a trained machine learning model for use in examples of the present disclosure. In some examples, a system such as the machine learning system 600 of FIG. 6 is used to implement the machine learning pipeline 700.

The machine learning pipeline 700 commences with a data collection and preprocessing stage 702, in which data is acquired, cleaned, or formatted for compatibility with machine learning algorithms. The data collection and preprocessing stage 702 may also involve addressing issues such as duplicate entries, missing values, or data inconsistencies.

During a feature engineering stage 704, training data can be formatted, transformed, or selected as needed to create features that are useful for predicting target data. Feature engineering may include (1) receiving features (e.g., as structured or labeled data in supervised learning) and/or (2) identifying features (e.g., unstructured or unlabeled data for unsupervised learning) in training data. In this context, a feature may be variable or attribute, such as a measurable property of a process, article, system, or phenomenon represented by a data set. Features may also be of different types, such as numeric features, strings, and graphs, and may include one or more of content, concepts, attributes, historical data, or user data, merely for example.

A model selection and training stage 706 can include selecting an appropriate machine learning algorithm or strategy and training the relevant model on training data. The model selection and training stage 706 may involve splitting the data into training and testing sets, using cross-validation to evaluate the model, and tuning hyperparameters to improve performance. During training, the model may be trained to find features that affect a predicted outcome. The result of the training is a trained machine learning model.

In some examples, techniques such as model quantization, pruning, or knowledge distillation can reduce the computational complexity of a trained model. Quantization involves reducing the precision of weights and activations (e.g., from 32-bit floating-point to 8-bit integers), enabling efficient deployment on hardware-constrained environments such edge devices. Pruning removes redundant or non-contributory connections within a model, thereby reducing memory and processing requirements. Knowledge distillation transfers the learned knowledge of a large, complex model into a smaller, lightweight model.

A model evaluation stage 708 may include evaluating the performance of a trained model on a separate testing dataset. This can help determine if the model is overfitting or underfitting and determine whether the model is suitable for deployment. Regularization techniques, such as dropout or L2 regularization, may also be employed to prevent overfitting and improve generalization.

FIG. 7 further shows an inference stage 710, in which a trained model generates outputs on new, unseen data. For example, for each input, at operation 716, the model receives input data (e.g., from external sources, such as real-time sensors, databases, or user-provided queries, or internal sources such as test inputs). At operation 718, the trained model processes the input data. This can include various operations that are performed to arrive at output data, such as feature extraction, transformation, and embedding generation, depending on the model architecture. For example, a CNN may process input images by applying convolutional filters, while a transformer model might encode textual input using self-attention mechanisms. The trained model may perform inference, mapping inputs to outputs, such as predictions or classifications, thereby providing the output data at operation 720.

It is noted that output data may take various forms. In classification AI examples, outputs may include data classifications or probabilities linked to particular classifications. In generative AI examples, outputs may include new content, such as translations, summaries, answers, new media content, or combinations thereof. In some examples, outputs are further processed into usable output, such as probabilities, labels, or continuous values tailored for downstream systems. Post-processing may include confidence scoring, aggregation, or error correction, to ensure outputs are accurate and actionable for the intended application.

The machine learning pipeline 700 may also include a validation, refinement, or retraining stage 712. This may include updating a model based on feedback generated from the inference stage 710, such as new data or user feedback. In some examples, validation is performed a separate dataset known as the validation dataset. The validation dataset can be used to tune or fine-tune the hyperparameters of a model, such as the learning rate and the regularization parameter. The hyperparameters may be adjusted to improve the model's performance on the validation dataset.

During deployment stage 714, the trained model is integrated into or connected with a more extensive or real-world system, application, or environment, such as a web service, mobile app, or Internet of Things (IoT) device. This phase can involve setting up APIs, building a user interface, and ensuring that the model is scalable and can handle large volumes of data. In some examples, the trained model is deployed on a single device, such as locally on an end user's computing device or on an edge device, as opposed to being deployed on a server system. This may provide lower latency or offline functionality in certain scenarios. Accordingly, various trained models can be deployed as server-based deployments or on-device deployments.

In some examples, a trained model includes one or more neural networks. The neural network may include a hierarchical (e.g., layered) organization of neurons or nodes, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

A neural network can be applied in various scenarios. In some cases, the neural network is configured to perform an image or video processing task. For example, the task may be image classification. As another example, the task can be image embedding generation and the output generated by the neural network can be a numeric embedding of the input image. As yet another example, the task can be object detection and the output generated by the neural network can identify locations in the input image at which particular types of objects are depicted. As another example, if the input to the neural network is a sequence of text in one language, the output generated by the neural network may be a piece of text in the other language that is a predicted proper translation of the input text into the other language.

In some cases, a machine learning task is a multi-modal processing task that requires processing multi-modal data. In general, multi-modal data is a combination of two or more different types of data, e.g., two or more of audio data, image data, text data, or graph data. As one example, the multi-modal data may comprise audio-visual data, comprising a combination of pixels of an image or of video and audio data representing values of a digitized audio waveform. As another example, the multi-modal data may comprise a combination of text data representing text in a natural language and pixels of an image.

In some examples, the neural network may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

As mentioned, a generative AI model can generate new content. For example, generative AI can produce text, images, video, audio, code, or synthetic data. In some examples, the generated content may be similar to original data, but not identical.

Some of the techniques or architectures that may be used in generative AI are GANs, Variational autoencoders (VAEs), and transformers. GANs may include two neural networks: a generator and a discriminator. The generator network attempts to create realistic content that can “fool” the discriminator network, while the discriminator network attempts to distinguish between real and fake content. The generator and discriminator networks compete with each other and improve over time. VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models may use attention mechanisms to learn the relationships between different parts of input data (such as words or pixels) and generate output data based on these relationships. In some examples, transformer models can handle sequential data, such as text or speech, as well as non-sequential data, such as images or code.

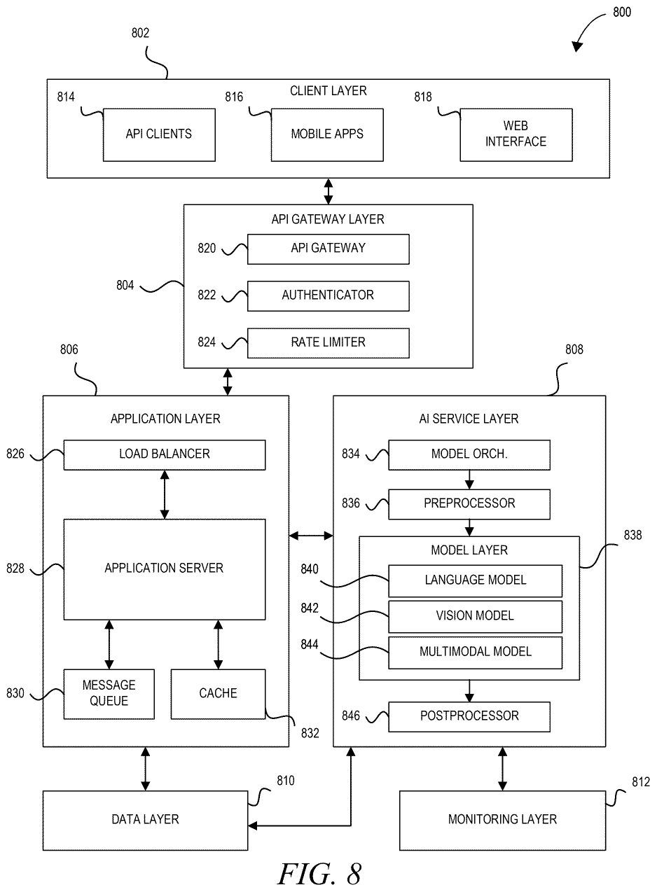

FIG. 8 is a system architecture diagram showing a layered view of an AI integrated system 800, according to some examples. The AI integrated system 800 comprises six example layers: a client layer 802, an API gateway layer 804, an application layer 806, an AI service layer 808, a data layer 810, and a monitoring layer 812.

The client layer 802 provides multiple access points for system interaction. It includes API clients 814, which may enable programmatic access to the capabilities of the AI integrated system 800 or integration with third-party systems and services. Mobile applications 816 facilitate access from mobile applications and devices, for example implementing native mobile protocols while maintaining consistent communication patterns with backend systems. A web interface 818 enables browser-based access to the capabilities of the AI integrated system 800 and may communicate with other layers using, for example, Hypertext Transfer Protocol (HTTP) or Hypertext Transfer Protocol Secure (HTTPS) protocols.

The API gateway layer 804 serves as an entry point for client communications. The API gateway layer 804 comprises an API gateway 820, which may implement routing logic to direct incoming requests to appropriate backend services. An authenticator 822 validates client credentials, for example using industry-standard protocols, such as OAuth 2.0 (Open Authorization 2.0) or JWT (JSON Web Tokens). In some examples, a rate limiter 824 of the API gateway layer 804 operates to prevent system abuse or ensure resource allocation among clients.

The application layer 806 comprises various processing capabilities. In some examples, the application layer 806 includes a load balancer 826 that may distribute incoming requests across multiple application server instances to support resource utilization and system reliability. An application server 828 may implement business or core functional logic of the AI integrated system 800, processing requests and coordinating responses across various system components. In some examples, a message queue 830 facilitates asynchronous processing capabilities, enabling efficient handling of operations, and a cache 832 operates within the application layer 806 to improve response times for frequently requested data.

The AI service layer 808 provides AI capabilities through a structured approach to model deployment and execution. In some examples, the AI service layer 808 includes a model orchestrator 834 that coordinates the execution of one or various AI models, managing resource allocation and implementing routing logic to direct requests to appropriate model instances. A preprocessor 836 may prepare input data for model consumption, implementing transformations, validations, or other preprocessing operations.

FIG. 8 shows the AI service layer 808 as include a model layer 838. The model layer 838 may include multiple model types, including, for example, one or more of: a language model 840 for processing textual input, implementing natural language processing capabilities; a vision model 842 for handling image or video processing tasks; and a multimodal model 844 that combines multiple input types to provide comprehensive analysis capabilities. In some examples, a postprocessor 846 of the AI service layer 808 transforms model outputs into standardized formats suitable for client consumption. The data layer 810 provides persistent storage capabilities.

While not detailed in FIG. 8, it is noted that the data layer 810 may include various components such as a primary database for maintaining transactional data, a vector database for optimizing storage and retrieval of high-dimensional vectors used in AI applications and models of the AI service layer 808, or a file storage component for managing binary data assets.

The monitoring layer 812 may provide observability capabilities across the AI integrated system 800. This may include logging for capturing system events, metrics collection for performance analysis, or distributed tracing for detailed analysis of request flow through the system.

Communication between layers of the AI integrated system 800 may follow defined patterns. External communications may implement appropriate encryption protocols, for example utilizing Transport Layer Security (TLS) or Secure Sockets Layer (SSL) for data protection. Internal communications may use various protocols selected for specific use cases, for example, Hypertext Transfer Protocol version 2 (HTTP/2), gRPC (Google Remote Procedure Call), or proprietary protocols where appropriate.

Referring again to the model layer 838, this layer may incorporate various types of machine learning models. Neural networks may be deployed to implement various architectures suited to specific processing needs. These can include, merely for example, fundamental feedforward neural networks for pattern recognition, convolutional neural networks (CNNs, neural networks that may be specialized for processing visual information), recurrent neural networks (RNNs, neural networks that may be designed for sequential data), transformer networks, or other architectures (e.g., Long Short-Term Memory networks (LSTMs) or Gated Recurrent Units (GRUs)).

A language model such as the language model 840 may use transformer-based architectures (e.g., Bidirectional Encoder Representations from Transformers (BERT), Generative Pre-trained Transformer (GPT) variants, or Text-to-Text Transfer Transformer (T5)) for processing textual data and implementing natural language understanding capabilities. A vision model such as the vision model 842 may employ specialized neural network architectures (e.g., CNNs, Vision Transformers (ViT), or Residual Neural Network (ResNet) variants) for processing visual information and extracting features from images or video streams. A multimodal model such as the multimodal model 844 may implement hybrid architectures (e.g., Contrastive Language-Image Pre-training (CLIP), DALL-E variants, or multimodal transformers) designed to process and correlate information across different input modalities, leveraging ensemble approaches to combine multiple model types using model aggregation or weighted prediction strategies. A multimodal model may combine textual, visual, and other forms of input data to provide analysis and generate integrated outputs that leverage cross-modal understanding capabilities.

The AI service layer 808 may provide both supervised learning models (e.g., decision trees, random forests, or support vector machines) for specific classification and prediction tasks, and unsupervised learning models (e.g., k-means clustering or principal component analysis) for pattern discovery and dimensionality reduction within the data processing pipeline. Probabilistic models (e.g., Bayesian networks or hidden Markov models) may be integrated within the AI service layer 808 to handle uncertainty in decision-making processes, working in conjunction with the preprocessor 836 and postprocessor 846 components to provide probability estimates and confidence metrics for model outputs.

Each model type may be implemented using various deployment strategies, with the model orchestrator 834 managing their execution and resource allocation to ensure adequate performance and efficient system operation. This may include coordinating the deployment and execution of various model types, ensuring efficient resource allocation, and appropriate model selection based on specific task requirements. While in some examples the model layer 838 provides server-based access to one or more models, a model can alternatively (or additionally) be deployed so as to perform inference locally (e.g., at the client layer 802).

In view of the disclosure above, various examples are set forth below. It should be noted that one or more features of an example, taken in isolation or combination, should be considered within the disclosure of this application.

Example 1 is a system comprising: at least one hardware processor; a computer-readable medium storing instructions that, when executed by the at least one hardware processor, cause the at least one hardware processor to perform operations comprising: splitting a document token sequence into global chunks; generating token-level embeddings for each token in each global chunk using an embedding machine learning model, the token-level embedding being a vector representation of meaning; dividing each global chunk into sub-chunks; computing a global average of all token-level embeddings for each global chunk; computing a local average embedding of all token-level embeddings for each sub-chunk; generating a final embedding for each sub-chunk by computing a weighted average of the local average embedding and a difference between the global average and the local average embedding; receiving a user request to generate content based on data; generating a query embedding using by passing the data through the embedding machine learning model; locating one or more similar final embeddings to the query embedding; and generating a prompt to a first Large Language Model (LLM) using the request and the one or more similar final embeddings; and sending the prompt to the first LLM to generate a response to the request.

In Example 2, the subject matter of Example 1 includes, wherein the document token sequence is generated by passing the document through a tokenizer.

In Example 3, the subject matter of Examples 1-2 includes, wherein the weighted average applies a weight of a to the local average embedding and a weight of one minus α to the difference between the global average and the local average embedding for a corresponding sub-chunk, wherein α is a value between zero and one.

In Example 4, the subject matter of Example 3 includes, wherein α is learned by a machine learning algorithm.

In Example 5, the subject matter of Examples 3-4 includes, wherein α is dynamically adjusted based on user feedback regarding the generated response.

In Example 6, the subject matter of Examples 1-5 includes, wherein the dividing comprises: dividing the global chunk into a plurality of initial sub-chunks; passing each of the initial sub-chunks to a second LLM to generate a summary of each initial sub-chunk; and for each summary after a first summary, iteratively performing: passing a corresponding summary to the second LLM to determine whether the corresponding summary continues an idea from an immediately preceding summary; and in response to a determination that the corresponding summary continues an idea from an immediately preceding summary, combining the initial sub-chunk for the corresponding summary with the initial sub-chunk for the immediately preceding summary.

In Example 7, the subject matter of Example 6 includes, wherein the dividing the global chunk into a plurality of initial sub-chunks comprises dividing the global chunk based on markers in the document.

In Example 8, the subject matter of Example 7 includes, wherein the document is a Markup document converted from an original document in a format other than Markup.

Example 9 is a method comprising splitting a document token sequence into global chunks; generating token-level embeddings for each token in each global chunk using an embedding machine learning model, the token-level embedding being a vector representation of meaning; dividing each global chunk into sub-chunks; computing a global average of all token-level embeddings for each global chunk; computing a local average embedding of all token-level embeddings for each sub-chunk; generating a final embedding for each sub-chunk by computing a weighted average of the local average embedding and a difference between the global average and the local average embedding; receiving a user request to generate content based on data; generating a query embedding using by passing the data through the embedding machine learning model; locating one or more similar final embeddings to the query embedding; and generating a prompt to a first Large Language Model (LLM) using the request and the one or more similar final embeddings; and sending the prompt to the first LLM to generate a response to the request.

In Example 10, the subject matter of Example 9 includes, wherein the document token sequence is generated by passing the document through a tokenizer.

In Example 11, the subject matter of Examples 9-10 includes, wherein the weighted average applies a weight of α to the local average embedding and a weight of one minus α to the difference between the global average and the local average embedding for a corresponding sub-chunk, wherein α is a value between zero and one.

In Example 12, the subject matter of Example 11 includes, wherein α is learned by a machine learning algorithm.

In Example 13, the subject matter of Examples 11-12 includes, wherein α is dynamically adjusted based on user feedback regarding the generated response.

In Example 14, the subject matter of Examples 9-13 includes, wherein the dividing comprises: dividing the global chunk into a plurality of initial sub-chunks; passing each of the initial sub-chunks to a second LLM to generate a summary of each initial sub-chunk; and for each summary after a first summary, iteratively performing: passing a corresponding summary to the second LLM to determine whether the corresponding summary continues an idea from an immediately preceding summary; and in response to a determination that the corresponding summary continues an idea from an immediately preceding summary, combining the initial sub-chunk for the corresponding summary with the initial sub-chunk for the immediately preceding summary.

In Example 15, the subject matter of Example 14 includes, wherein the dividing the global chunk into a plurality of initial sub-chunks comprises dividing the global chunk based on markers in the document.

In Example 16, the subject matter of Example 15 includes, wherein the document is a Markup document converted from an original document in a format other than Markup.

Example 17 is a non-transitory machine-readable medium storing instructions which, when executed by one or more processors, cause the one or more processors to perform operations comprising: splitting a document token sequence into global chunks; generating token-level embeddings for each token in each global chunk using an embedding machine learning model, the token-level embedding being a vector representation of meaning; dividing each global chunk into sub-chunks; computing a global average of all token-level embeddings for each global chunk; computing a local average embedding of all token-level embeddings for each sub-chunk; generating a final embedding for each sub-chunk by computing a weighted average of the local average embedding and a difference between the global average and the local average embedding; receiving a user request to generate content based on data; generating a query embedding using by passing the data through the embedding machine learning model; locating one or more similar final embeddings to the query embedding; and generating a prompt to a first Large Language Model (LLM) using the request and the one or more similar final embeddings; and sending the prompt to the first LLM to generate a response to the request.

In Example 18, the subject matter of Example 17 includes, wherein the document token sequence is generated by passing the document through a tokenizer.

In Example 19, the subject matter of Examples 17-18 includes, wherein the weighted average applies a weight of a to the local average embedding and a weight of one minus α to the difference between the global average and the local average embedding for a corresponding sub-chunk, wherein α is a value between zero and one.

In Example 20, the subject matter of Example 19 includes, wherein α is learned by a machine learning algorithm.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

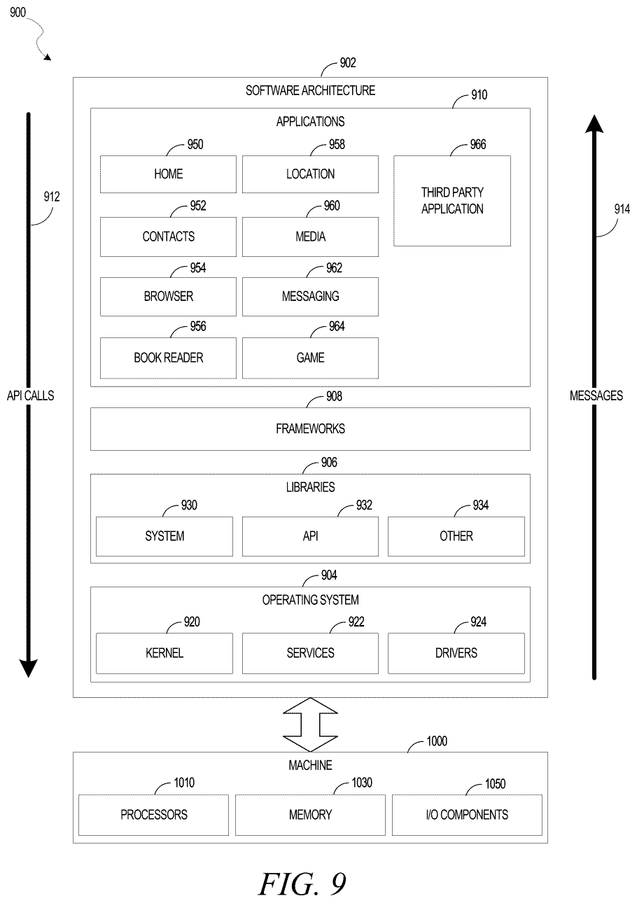

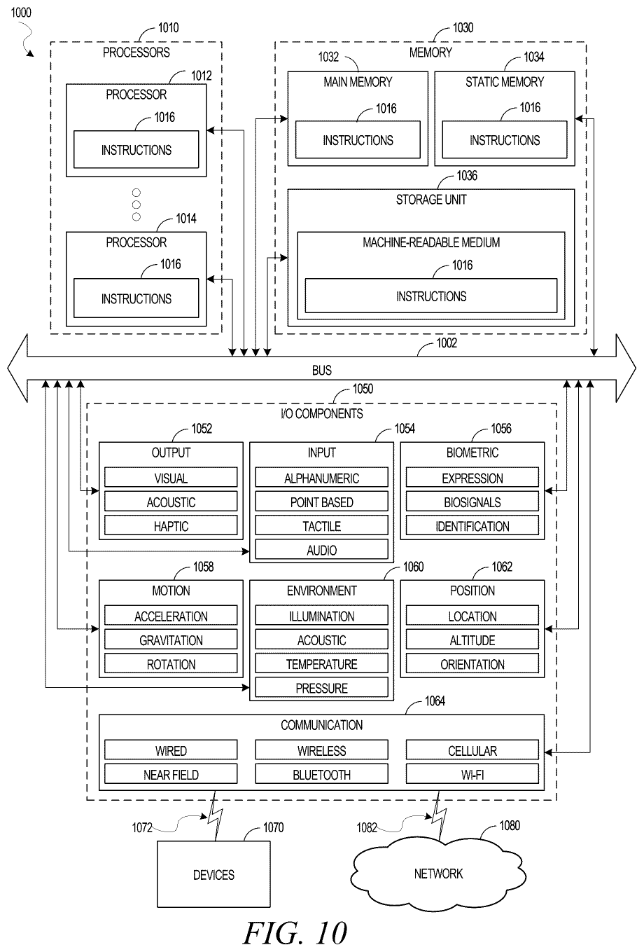

FIG. 9 is a block diagram 900 illustrating a software architecture 902, which can be installed on any one or more of the devices described above. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example architecture, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionalities. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various GUI functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute the method 100 of FIG. 1. Additionally, or alternatively, the instructions 1016 may implement FIGS. 1-8 and so forth. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions 1016 contemporaneously. Although FIG. 10 shows multiple processors 1010, the machine 1000 may include a single processor 1012 with a single core, a single processor 1012 with multiple cores (e.g., a multi-core processor 1012), multiple processors 1012, 1014 with a single core, multiple processors 1012, 1014 with multiple cores, or any combination thereof.

The memory 1030 may include a main memory 1032, a static memory 1034, and a storage unit 1036, each accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In various example embodiments, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., coupled via a USB).

Moreover, the communication components 1064 may detect identifiers or include components operable to detect identifiers. For example, the communication components 1064 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

The various memories (e.g., 1030, 1032, 1034, and/or memory of the processor(s) 1010) and/or the storage unit 1036 may store one or more sets of instructions 1016 and data structures (e.g., software) embodying or utilized by any one or more of the methodologies or functions described herein. These instructions (e.g., the instructions 1016), when executed by the processor(s) 1010, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor;
a computer-readable medium storing instructions that, when executed by the at least one hardware processor, cause the at least one hardware processor to perform operations comprising:
splitting a document token sequence into global chunks;
generating token-level embeddings for each token in each global chunk using an embedding machine learning model, the token-level embedding being a vector representation of meaning;
dividing each global chunk into sub-chunks;
computing a global average of all token-level embeddings for each global chunk;
computing a local average embedding of all token-level embeddings for each sub-chunk;
generating a final embedding for each sub-chunk by computing a weighted average of the local average embedding and a difference between the global average and the local average embedding;
receiving a user request to generate content based on data;
generating a query embedding using by passing the data through the embedding machine learning model;
locating one or more similar final embeddings to the query embedding; and
generating a prompt to a first Large Language Model (LLM) using the request and the one or more similar final embeddings; and
sending the prompt to the first LLM to generate a response to the request.

2. The system of claim 1, wherein the document token sequence is generated by passing the document through a tokenizer.

3. The system of claim 1, wherein the weighted average applies a weight of a to the local average embedding and a weight of one minus α to the difference between the global average and the local average embedding for a corresponding sub-chunk, wherein α is a value between zero and one.

4. The system of claim 3, wherein α is learned by a machine learning algorithm.

5. The system of claim 3, wherein α is dynamically adjusted based on user feedback regarding the generated response.

6. The system of claim 1, wherein the dividing comprises:
dividing the global chunk into a plurality of initial sub-chunks;
passing each of the initial sub-chunks to a second LLM to generate a summary of each initial sub-chunk; and
for each summary after a first summary, iteratively performing:
passing a corresponding summary to the second LLM to determine whether the corresponding summary continues an idea from an immediately preceding summary; and
in response to a determination that the corresponding summary continues an idea from an immediately preceding summary, combining the initial sub-chunk for the corresponding summary with the initial sub-chunk for the immediately preceding summary.

7. The system of claim 6, wherein the dividing the global chunk into a plurality of initial sub-chunks comprises dividing the global chunk based on markers in the document.

8. The system of claim 7, wherein the document is a Markup document converted from an original document in a format other than Markup.

9. A method comprising
splitting a document token sequence into global chunks;
generating token-level embeddings for each token in each global chunk using an embedding machine learning model, the token-level embedding being a vector representation of meaning;
dividing each global chunk into sub-chunks;
computing a global average of all token-level embeddings for each global chunk;
computing a local average embedding of all token-level embeddings for each sub-chunk;
generating a final embedding for each sub-chunk by computing a weighted average of the local average embedding and a difference between the global average and the local average embedding;
receiving a user request to generate content based on data;
generating a query embedding using by passing the data through the embedding machine learning model;
locating one or more similar final embeddings to the query embedding; and
generating a prompt to a first Large Language Model (LLM) using the request and the one or more similar final embeddings; and
sending the prompt to the first LLM to generate a response to the request.

10. The method of claim 9, wherein the document token sequence is generated by passing the document through a tokenizer.

11. The method of claim 9, wherein the weighted average applies a weight of a to the local average embedding and a weight of one minus α to the difference between the global average and the local average embedding for a corresponding sub-chunk, wherein α is a value between zero and one.

12. The method of claim 11, wherein α is learned by a machine learning algorithm.

13. The method of claim 11, wherein α is dynamically adjusted based on user feedback regarding the generated response.

14. The method of claim 9, wherein the dividing comprises:
dividing the global chunk into a plurality of initial sub-chunks;
passing each of the initial sub-chunks to a second LLM to generate a summary of each initial sub-chunk; and
for each summary after a first summary, iteratively performing:
passing a corresponding summary to the second LLM to determine whether the corresponding summary continues an idea from an immediately preceding summary; and
in response to a determination that the corresponding summary continues an idea from an immediately preceding summary, combining the initial sub-chunk for the corresponding summary with the initial sub-chunk for the immediately preceding summary.

15. The method of claim 14, wherein the dividing the global chunk into a plurality of initial sub-chunks comprises dividing the global chunk based on markers in the document.

16. The method of claim 15, wherein the document is a Markup document converted from an original document in a format other than Markup.

17. A non-transitory machine-readable medium storing instructions which, when executed by one or more processors, cause the one or more processors to perform operations comprising:
splitting a document token sequence into global chunks;
generating token-level embeddings for each token in each global chunk using an embedding machine learning model, the token-level embedding being a vector representation of meaning;
dividing each global chunk into sub-chunks;
computing a global average of all token-level embeddings for each global chunk;
computing a local average embedding of all token-level embeddings for each sub-chunk;
generating a final embedding for each sub-chunk by computing a weighted average of the local average embedding and a difference between the global average and the local average embedding;
receiving a user request to generate content based on data;
generating a query embedding using by passing the data through the embedding machine learning model;
locating one or more similar final embeddings to the query embedding; and
generating a prompt to a first Large Language Model (LLM) using the request and the one or more similar final embeddings; and
sending the prompt to the first LLM to generate a response to the request.

18. The non-transitory machine-readable medium of claim 17, wherein the document token sequence is generated by passing the document through a tokenizer.

19. The non-transitory machine-readable medium of claim 17, wherein the weighted average applies a weight of a to the local average embedding and a weight of one minus α to the difference between the global average and the local average embedding for a corresponding sub-chunk, wherein α is a value between zero and one.

20. The non-transitory machine-readable medium of claim 19, wherein α is learned by a machine learning algorithm.
